(19) United States
(12) Patent Application Publication
(10) Pub. No.: US 2026/0210752 A1
(43) Pub. Date: Jul. 23, 2026

(54) SYSTEM AND METHOD FOR WEIGHING CONTAINERS

(71) Applicant: Autostore Technology AS, Nedre Vats (NO)

(72) Inventor: Trond Austrheim, Etne (NO)

(73) Assignee: Autostore Technology AS, Nedre Vats (NO)

(21) Appl. No.: 19/140,926

(22) PCT Filed: Dec. 18, 2023
(86) PCT No.: PCT/EP2023/086405

§ 371 Date: Jun. 18, 2025

(30) Foreign Application Priority Data
Dec. 20, 2022 (NO) 20221367

(51) Int. Cl. G01G 15/00; B65G 1/04

(52) U.S. Cl. CPC G01G 15/006; B65G 1/0464; G01G 2015/008

(57) ABSTRACT

System for weighing containers in a rotatable container carousel rotating about a central axis and comprising a central hub with at least one carousel arm attached at one end to the central hub and at the other end attached to a container handling mechanism, at a radial distance between the central axis of the rotatable container carousel, allowing rotation from at least a container loading position and a container accessing position, wherein the container handling mechanism comprising a container holding tray mounted on top of the support structure which is attached to at least one wheel resting on a base and wherein the carousel arm can rotate around an axis going through the center of each attachment point of the carousel arm to the central hub and the container handling mechanism, and that when the carousel arm with the container handling mechanism comprising a container holding tray mounted on top of the support structure which is attached to at least one wheel is in the container accessing position, the at least one wheel is resting on a load cell.

### FIELD OF THE INVENTION

The present invention relates to an automated storage and retrieval system for storage and retrieval of containers, in particular to a system and method for weighing containers in a carousel port in a storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

In the prior art the containers in a carousel port in a storage and retrieval system is comprised of switches with pressure springs. This solution is mounted in each tray for carrying a storage container. Since there are three arms in a carousel port, hence there are three weighing points, one for each arm.

A problem with these solutions is that they can sometimes be unreliable in the sense that it is not precise enough, especially if the container is not positioned properly in the tray like a skew loaded bin.

### SUMMARY OF THE INVENTION

The present invention relates to a carousel port comprising a rotatable container carousel for conveying containers between a container loading position and a container accessing position, the container carousel being rotatable about a central axis and comprising a hub with at least one carousel arm attached at one end to the hub and at the other end attached to a support structure which carries a container tray at a radial distance from the central axis of the container carousel supported on top of the support structure at a center point of the support structure, wherein load from the support structure, the container tray and any container carried on the container tray is carried by at least one wheel mounted to the support structure of each carousel arm as the at least one wheel rotates over a surface of a base of the carousel port, characterized in that each carousel arm is able to pivot about a horizontal axis extending through a center of an attachment point of the carousel arm to the hub, and in that the base is provided with a load cell which is positioned so that when the carousel arm is in the container accessing position, the at least one wheel is resting on the load cell to register a weight applied by the at least one wheel.

In one aspect, the at least one carousel arm is comprised of an upper arm and a lower arm which extend parallel to each other.

In one aspect, each of the attachment points of the carousel arms has bearings in order to allow distal ends of the arms to move freely up and down in a vertical direction.

In one aspect, the upper arm and the lower arm are attached to each other at each end via a vertical member.

In one aspect, the upper arm, the lower arm and the vertical member can rotate around horizontal axes going through a center of each attachment point.

In one aspect, the support structure of each carousel arm is carried by two wheels spaced either side of the center point of the support structure, wherein each wheel is resting rest on separate load cells when the carousel arm is in the container accessing position.

In one aspect, the carousel port is comprised of there are three arms each with their own tray

In one aspect, the wheels can be driven wheels.

In one aspect, the adjustable legs of the carousel port at each corner are provided to support and assist levelling.

The present invention also relates to loading a container onto a tray of supported by an arm of a carousel port, rotate the arm with the tray with the container loaded onto it to the container access position, arranging each of the wheels attached to the rotating arm to rest on a load cell, registering a weight measurement output from the load cell, subtracting a weight measurement taken by the load cell when the container tray is empty.

The present invention also relates to a system for weighing containers in a carousel port in an automated storage and retrieval system which is comprising a plurality of container handling vehicles and a framework structure forming a three-dimensional storage grid structure for storing storage containers for storing items, and where the framework structure comprises a rail system, the rail system providing available routes for the container handling vehicles handling and transferring the storage containers to and from the storage columns, and wherein the carousel port can receive a container lowered by a container handling vehicle operating on the grid-based rail system of a storage volume of an automated storage and retrieval system automated storage comprising a rotatable container carousel for conveying containers between a container loading position and a container accessing position, the container carousel being rotatable about a central axis and comprising a hub with at least one carousel arm attached at one end to the hub and at the other end attached to a support structure which carries a container tray at a radial distance from the central axis of the container carousel supported on top of the support structure at a center point of the support structure, wherein load from the support structure, the container tray and any container carried on the container tray is carried by at least one wheel mounted to the support structure of each carousel arm as the at least one wheel rotates over a surface of a base of the carousel port characterized in that that each carousel arm is able to pivot about a horizontal axis extending through a center of an attachment point of the carousel arm to the hub, and in that the base is provided with a load cell which is positioned so that when the carousel arm is in the container accessing position, the at least one wheel is resting on the load cell to register a weight applied by the at least one wheel.

Using this solution, the weight of the container is measured properly even if the container is not loaded correctly in the tray.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a side view of a prior art solution where the container placed in the trays are measured using a switch with a pressure spring.

FIG. 6 is a side view of an embodiment of the present invention wherein the parts of the carousel ports are displayed.

FIG. 7 is a perspective view of the same embodiment as shown in FIG. 6 displaying that each of the arms has two wheels.

FIG. 8 is a perspective view from below displaying the weight sensors.

FIG. 9 is a close up, side view of one of the arms.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

The framework structure 100 of the automated storage and retrieval system 1 is constructed in a similar manner to the prior art framework structure 100 described above in connection with FIGS. 1-440. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

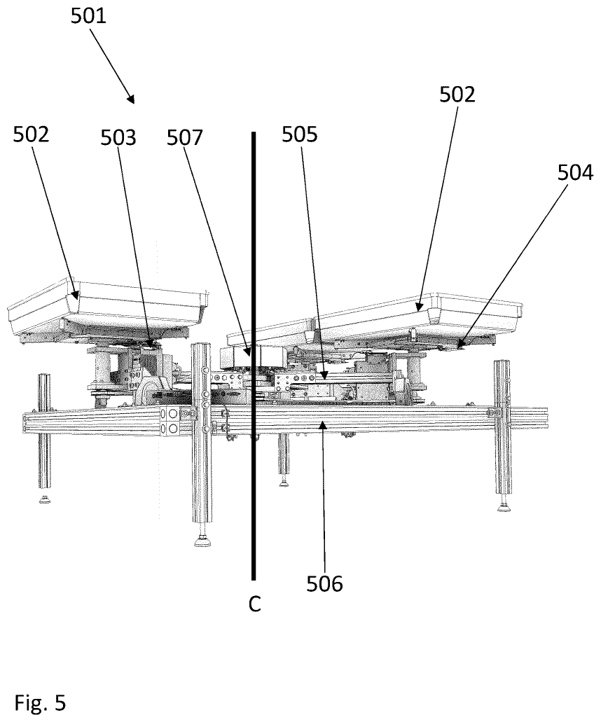

One embodiment of the automated storage and retrieval system according to the invention will now be discussed in more detail with reference to FIGS. 5-9.

FIG. 5 is a side view of a prior art solution where the container is placed in the trays are measured using a switch with a pressure spring.

The container carousel comprises a carousel support 506, a circular carousel base 701 connected to the carousel support 506, a hub containing a motor 507 fixed at a center point of the circular carousel base 701, three carousel arms extending between the hub and a structure at the radial boundary/circumference of the circular carousel base, one or more carousel motors causing rotation of the carousel arms around the hub and three trays into or onto which storage containers 106 may be supported.

In order to allow the storage containers 106 to keep their orientation during rotation, or to choose a desired orientation other than the initial, one or more belts may be arranged around an axle fixing the hub to the carousel base and around the coupling point of each of the storage container supports. The latter configuration requires that the coupling between the support and the respective carousel arm is rotatable.

When a container handling vehicle has delivered a container in an empty tray in the carousel port, an operator will arrange by means of a control device for the carousel port to be rotated around a central axis, thereby causing the tray containing the container to be brought to the opening in the work station.

While an operator is picking out the goods item or items from the container, another container handling vehicle will have found another container in the storage system and will have delivered this container in an empty tray in the carousel port.

When he or she has picked out the goods item or items from the first container, the operator will again arrange for the carousel port to be rotated, whereupon the new container delivered in the tray is rotated towards the opening in the work station.

While the operator picks out one or more goods items from the second container, a container handling vehicle will be able to retrieve the first container, so that the container can again be stored in the storage and retrieval system, while at the same time another container handling vehicle will be able to find a third container in the storage system. The third container will then be delivered in the empty tray in the device. When he or she has picked out one or more goods items from the second container, the operator will then once again arrange for the carousel port to be rotated, whereby the third container is brought to the operator for picking. The process of retrieval and delivery of containers in the carousel ports trays and the storage system is repeated until the goods item or items in a customer order have been selected and packed.

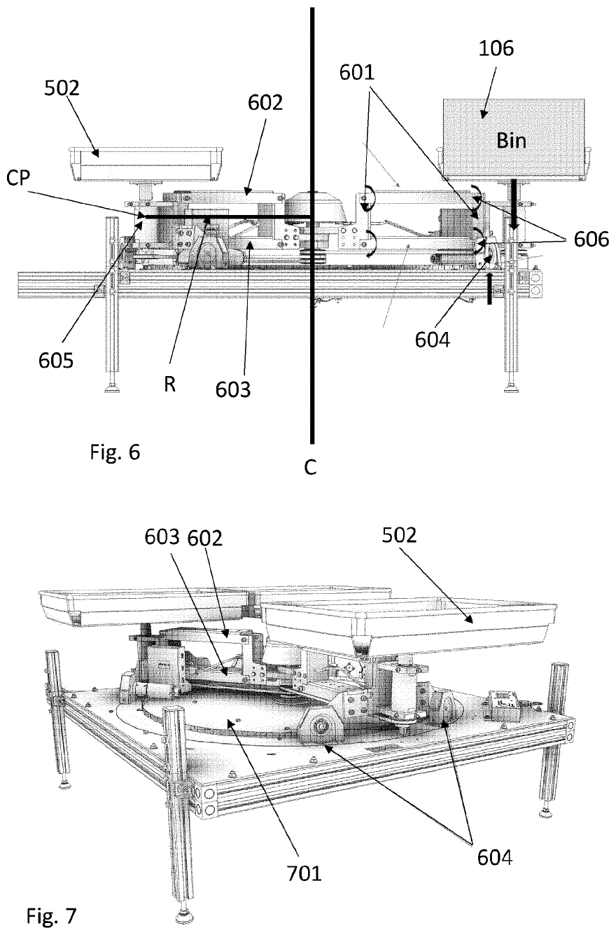

FIGS. 6 and 7 is a side view and a perspective view of an embodiment of the present invention wherein the parts of the carousel ports are displayed.

In this embodiment the arms stretch between the hub and a structure at the radial boundary/circumference of the circular carousel base. The arms are attached at each end and each attachment point of the arms are rotatable. The rotation can be realized using bearings. The reason for the rotation at the attachment points are in order for the arms not to influence the measurements of the weight cells.

There are three positions of the arms in the carousel. There is one picking position where an operator picks the container for the required items. This is also where the container is weighed. Further there is one delivery position where the container is lowered onto the tray from a container handling vehicle. And, there is a pick up position where the containers are picked up from the carousel after being picked for items by a container handling vehicle and transported back into the storage and retrieval system or to another port.

Further this embodiment of the present invention is comprised of a carousel support 506, a circular carousel base 701 connected to the carousel support 506, a hub 507 containing a motor fixed at a center point of the circular carousel base 701, three carousel arms extending between the hub and a structure at the radial boundary/circumference of the circular carousel base, one or more carousel motors causing rotation of the carousel arms around the hub and three trays into or onto which storage containers 106 may be supported.

The container carousel being rotatable about a central axis C going through the center of the hub 507 with at least one carousel arm 602, 603 attached at one end to the hub 507 and at the other end attached to a support structure for carrying a container tray at a radial distance R from the central axis C of the container carousel 501 supported on top of the support structure 605. Load from the support structure, the container tray and any container carried on the container tray is carried by at least one wheel 604 mounted to the support structure of each carousel arm as the at least one wheel rotates over a surface of a base of the carousel port.

The load from the support structure, the container tray and any container carried on the container tray is carried by at least one wheel 604 mounted to the support structure of each carousel arm as the at least one wheel rotates over a surface of a base of the carousel port. Each carousel arm 602, 603 is able to pivot about a horizontal axis extending through a center of an attachment point of the carousel arm 602, 603 to the hub 507, and in that the base is provided with a load cell which is positioned so that when the carousel arm 602, 603 is in the container accessing position, the at least one wheel is resting on the load cell to register a weight applied by the at least one wheel.

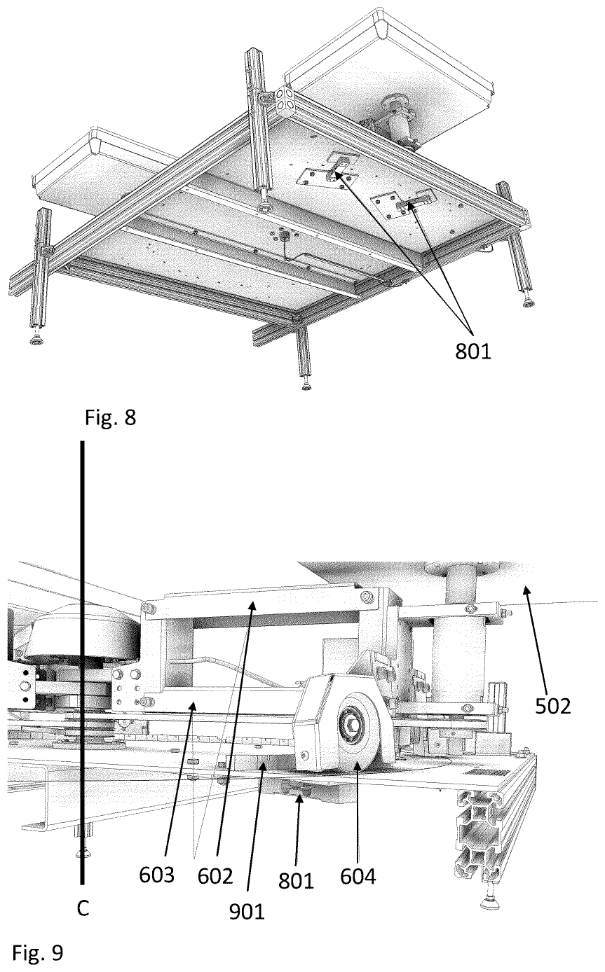

FIG. 8 is a perspective view from below displaying the weight sensors. Each arm has two wheels and the wheels rest on the base of the carousel port. When an arm is in the picking position the wheels rest on weight cells. The weight measured on both cells are added in order to get the correct weight. After the measured weights are added the weight of the arm without any container on top is deducted and the weight of a standard container is deducted. The formula is as follows:

$$Weight of items = ( {W}_{1} + {W}_{2} ) - ( {W}_{A} + {W}_{C} ) \qquad [ Formula 1 ]$$

Wherein W1=weight measured at first weight cell, W2=Weight measured at second weight cell, WA=Weight of arm without container, Wc=Weight of standard container.

FIG. 9 is a close up, side view of one of the arms. Displaying the position reading system. The position of the arms is detected by a circular ring creating a circumference around the hub of the carousel. The ring can have sensors along its circumference that allow the detection of the position of the arms. This can be due to magnetic fields.

The arms can be comprised of a single bar attached to the hub in one end and attached to the support system for the tray in the other end. The attachment points can rotate in order to ensure that the registering of the weight of the container is not affected by the arm.

The arms can be a parallelogram linkage like in an upper and a lower arm connected by a vertical member and the attachment points can rotate in order to ensure that the registering of the weight of the container is not affected by the arm. This provides an additional technical effect over a simple pivoted link arrangement of the tray being held in the same (horizontal) orientation regardless of the amount of movement at the pivots, which in this carousel port may not be that large a movement as the wheels are simply running around a flat base. It will allow the weight to transfer to the load cell and the parallel arm arrangement will also provide additional torsional stiffness without having to rely on larger sections.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

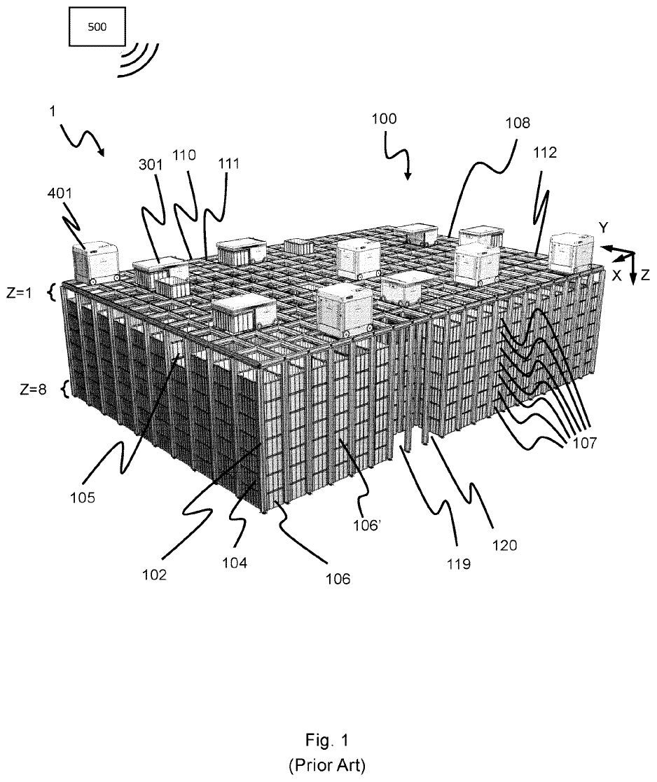

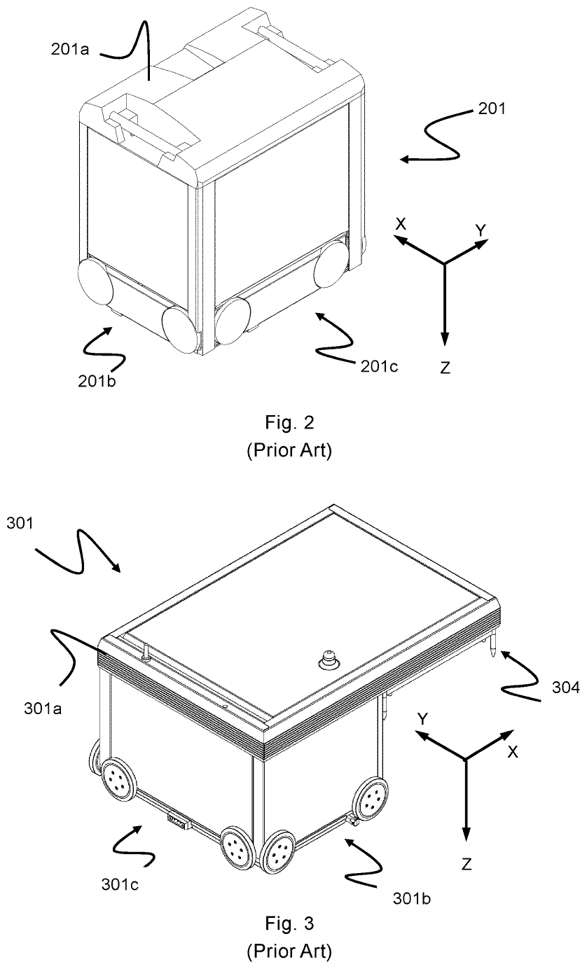

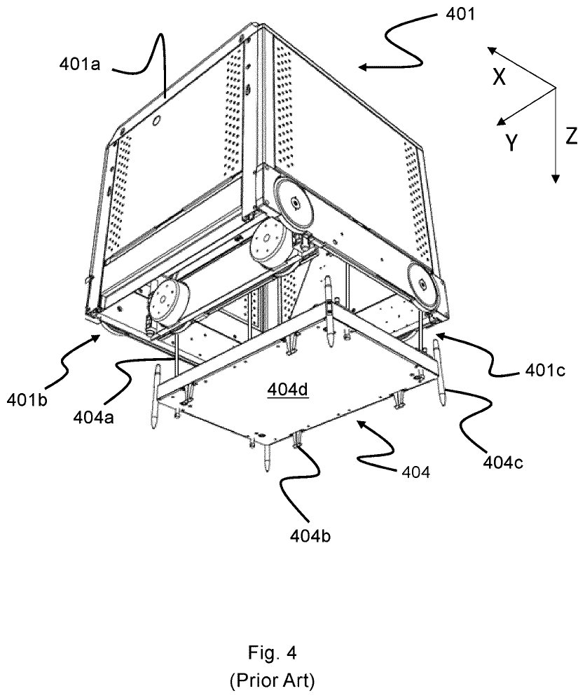

LIST OF REFERENCE NUMBERS
Prior art (FIGS. 1-4):

| | |
|---|---|
| 1 | Prior art automated storage and retrieval system |
| 100 | Framework structure |
| 102 | Upright members of framework structure |
| 104 | Storage grid |
| 105 | Storage column |
| 106 | Container |
| 106′ | Particular position of storage container |
| 107 | Stack |
| 108 | Rail system |
| 110 | Parallel rails in first direction (X) |
| 112 | Access opening |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels in first |
| | direction (X) |
| 201c | Drive means/wheel arrangement/second set of wheels in second |
| | direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 304 | Gripping device |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| 501 | Rotatable container carousel |
| 502 | Trey |
| 503 | Weight sensor |
| 504 | Position sensor |
| 505 | Arm |
| 506 | Carousel support |
| 507 | Central hub containing motor. |
| 601 | Vertical member |
| 602 | Upper parallel arm |
| 603 | Lower parallel arm |
| 604 | Wheel |
| 605 | Support structure |
| 606 | Attachment points of the carousel arm |
| 801 | Load cell |
| 901 | Sensor for reading of position of arm |
| 1001 | Band for revolving treys and arms around the central hub. |
| C | Central axis |
| R | Radius between central axis and central point of |
| | support structure |
| X | First direction |
| Y | Second direction |
| Z | Third direction |

1. A carousel port comprising:
a rotatable container carousel for conveying containers between a container loading position and a container accessing position, the rotatable container carousel being rotatable about a central axis and comprising:
a base;
a hub; and
at least one carousel arm attached at one end to the hub and at another end attached to a support structure which carries a container tray at a radial distance from the central axis of the rotatable container carousel supported on top of the support structure,
wherein load from the support structure, the container tray and any container carried on the container tray is carried by at least one wheel mounted to the support structure of each carousel arm of the at least one carousel arm as the at least one wheel rotates over a surface of the base of the carousel port, and
wherein each carousel arm of the at least one carousel arm is able to pivot about a horizontal axis extending through a center of an attachment point of the carousel arm to the hub, and
wherein the base is provided with a load cell which is positioned so that when the at least one carousel arm is in the container accessing position, the at least one wheel is resting on the load cell to register a weight applied by the at least one wheel.

2. The carousel port according to claim 1 wherein the at least one carousel arm is comprised of an upper arm and a lower arm which extend parallel to each other.

3. The carousel port according to claim 1 wherein each attachment point of the at least one carousel arm has bearings in order to allow a distal end of the at least one carousel arm to move freely up and down in a vertical direction.

4. The carousel port according to claim 2 wherein the upper arm and the lower arm are attached to each other at a first end via a first vertical member and at a second end via a second vertical member.

5. The carousel port according to claim 4 wherein the upper arm, the lower arm, the first vertical member, and the second vertical member can rotate around horizontal axes going through a center of each attachment point.

6. The carousel port according to claim 1, wherein the support structure of each carousel arm of the at least one carousel arm is carried by two wheels spaced either side of a center point of the support structure, wherein each wheel of the two wheels is resting on separate load cells when the at least one carousel arm is in the container accessing position.

7. The carousel port according to claim 1, wherein the carousel port comprises three carousel arms each with their own tray.

8. The carousel port according to claim 1, wherein the at least one wheel is a driven wheel.

9. The carousel port according to claim 1, further comprising adjustable legs positioned at each corner and provided to support and assist levelling of the carousel port.

10. A method for weighing containers in a carousel port comprising a rotatable container carousel for conveying containers between a container loading position and a container accessing position, the rotatable container carousel being rotatable about a central axis and comprising a hub with at least one carousel arm attached at one end to the hub and at another end attached to a support structure which carries a container tray at a radial distance from the central axis of the rotatable container carousel supported on top of the support structure, wherein load from the support structure, the container tray and any container carried on the container tray is carried by at least one wheel mounted to the support structure of each carousel arm of the at least one carousel arm as the at least one wheel rotates over a surface of a base of the carousel port, the method comprising the following steps:
loading a container onto a container tray supported by a carousel arm of the at least one carousel arm of the carousel port,
rotating the carousel arm with the container tray with the container loaded onto it to the container accessing position,
arranging the at least one wheel attached to the carousel arm rotated to the container accessing positioned to rest on a load cell,
registering a weight measurement output from the load cell, and
subtracting from the weight measurement a weight measurement taken by the load cell when the container tray is empty.

11. A system for weighing containers in a carousel port in an automated storage and retrieval system comprising:
a plurality of container handling vehicles; and
a framework structure forming a three-dimensional storage grid structure for storing storage containers for storing items, and where the framework structure comprises a rail system, the rail system providing available routes for the container handling vehicles handling and transferring the storage containers to and from storage columns of the automated storage and retrieval system, and
wherein the carousel port can receive a container lowered by a container handling vehicle operating on the rail system of the automated storage and retrieval system,
wherein the automated storage and retrieval system comprises a rotatable container carousel for conveying containers between a container loading position and a container accessing position, the rotatable container carousel being rotatable about a central axis and comprising:
a base;
a hub; and
at least one carousel arm attached at one end to the hub and at another end attached to a support structure which carries a container tray at a radial distance from the central axis of the rotatable container carousel supported on top of the support structure,
wherein load from the support structure, the container tray and any container carried on the container tray is carried by at least one wheel mounted to the support structure of each carousel arm of the at least one carousel arm as the at least one wheel rotates over a surface of the base of the carousel port, and
wherein each carousel arm of the at least one carousel arm is able to pivot about a horizontal axis extending through a center of an attachment point of the carousel arm to the hub, and
wherein the base is provided with a load cell which is positioned so that when the at least one carousel arm is in the container accessing position, the at least one wheel is resting on the load cell to register a weight applied by the at least one wheel.
